(19) United States
(12) Patent Application Publication
(10) Pub. No.: US 2025/0053424 A1
(43) Pub. Date: Feb. 13, 2025

(54) APPARATUS, METHOD, AND COMPUTER-READABLE MEDIUM FOR RECONFIGURING A SUPPORT PACKAGE FOR INITIALIZING FIRMWARE

(71) Applicant: Intel Corporation, Santa Clara, CA (US)

(72) Inventors: Rajesh POORNACHANDRAN, Portland, OR (US); Vincent J. ZIMMER, Issaquah, WA (US); Nilesh K. JAIN, Portland, OR (US)

(21) Appl. No.: 18/806,750

(22) Filed: Aug. 16, 2024

(51) Int. Cl. G06F 9/445

(52) U.S. Cl. CPC G06F 9/445

(57) ABSTRACT

An apparatus, method, and computer-readable medium for reconfiguring a support package for initializing firmware. The apparatus comprises memory, machine-readable instructions, and processor circuitry configured to execute the machine-readable instructions to intercept a write operation to a register of the processor circuitry requesting a configuration profile for the support package. The apparatus further selects an applet for the support package corresponding to the requested configuration profile, reconfigures the support package with the selected applet, and initializes firmware based on the reconfigured support package.

### BACKGROUND

When developing Basic Input/Output System (BIOS) code, Original Equipment Manufacturers (OEMs), Original Design Manufacturers (ODMs), and Cloud Service Providers (CSPs) commonly work with Independent Software Vendors (ISVs) to adapt reference firmware code written by chip manufacturers for use with their processors This is often called a Firmware Support Package (FSP). However, the lack of uniform adaptation of these by ISVs presents challenges, potentially leading to the loss of performance and power efficiency built into the reference firmware code. This issue is particularly crucial for processors positioned as general-purpose artificial intelligence (AI) inference and fine-tuning accelerators with Advanced Matrix Extensions (AMX) and general-purpose computing capabilities. End-users who expect processors to perform efficiently for demanding applications are hindered by these inefficiencies introduced by non-uniform firmware adaptation. Therefore, an improved apparatus, method, and computer-readable medium for reconfiguring a support package for initializing firmware may be desired.

### BRIEF DESCRIPTION OF THE FIGURES

Some examples of apparatuses and/or methods will be described in the following by way of example only and with reference to the accompanying figures, in which

FIG. 1 shows a block diagram of an example of an apparatus for reconfiguring a support package for initializing firmware;

FIG. 2 shows a FSP augmented with an AI Optimized Firmware Support Package (AIFSP);

FIG. 3 illustrates the system architecture for a FSP with the addition of the AIFSP;

FIG. 4 illustrates a system architecture for a FSP with components to support reconfiguring the FSP;

FIG. 5 shows a configurational flowchart to enable AIFSP by a fleet manager;

FIG. 6 shows an operational flowchart to trigger AIFSP applets from host code that has been pre-configured by the fleet manager;

FIG. 7 shows a flowchart of a method for reconfiguring a support package for initializing firmware; and

FIG. 8 illustrates a computing device for reconfiguring a support package for initializing firmware.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures, same or similar reference numerals refer to same or similar elements and/or features, which may be identical or implemented in a modified form while providing the same or a similar function. The thickness of lines, layers, and/or areas in the figures may also be exaggerated for clarification.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

When two elements A and B are combined using an “or,” this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a,” “an,” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include,” “including,” “comprise,” and/or “comprising,” when used, describe the presence of the specified features, integers, steps, operations, processes, elements, components, and/or a group thereof, but do not exclude the presence or addition of one or more other features, integers, steps, operations, processes, elements, components and/or a group thereof.

Unless otherwise defined, all terms (including technical and scientific terms) are used herein in their ordinary meaning of the art to which the examples belong.

Specific details are set forth in the following description, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply that the described element item must be in a given sequence, either temporally or spatially, in ranking, or in any other manner. “Connected” may indicate elements are in direct physical or electrical contact with each other, and “coupled” may indicate elements cooperate or interact with each other, but they may or may not be in direct physical or electrical contact.

As used herein, the terms “operating,” “executing,” or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

It should be noted that the example schemes disclosed herein are applicable for/with any operating system and a reference to a specific operating system in this disclosure is merely an example, not a limitation.

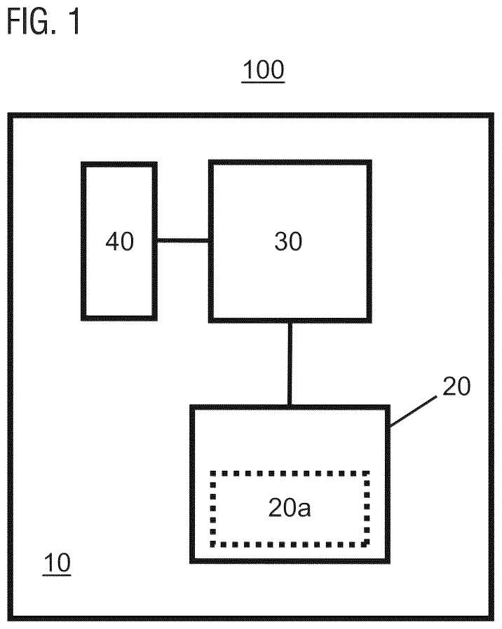

FIG. 1 shows a block diagram of an example of an apparatus 10 or device 10 comprising memory circuitry 20, machine-readable instructions 20a, and processor circuitry 30 to execute the machine-readable instructions. The processor circuitry 30 may be configured to intercept a write operation to a register of the processor circuitry 30 requesting a configuration profile for the support package, select an applet for the support package corresponding to the requested configuration profile, reconfigure the support package with the selected applet, and initialize firmware based on the reconfigured support package.

The disclosed approach addresses a challenge in terms of how a chip manufacturer can provide certain optimized firmware support packages (FSPs), such as an AI Optimized Firmware Support Package (AIFSP) for efficient AI acceleration, which is opaque to Independent Software Vendors (ISV) adaptation of the chip maker's firmware, thereby reaching to end-users and their applications more effectively. Micro-architectural features of processors have different impacts for different AI use cases (e.g. Large Language Models (LLM) vs. Recommender systems vs. Image Recognition), and there is no one-size-fits-all solution. As a result, having the capability to understand the workload affinity to specific platform features and deactivating or activating them seamlessly is key to more effective use of the processor. Tailoring the firmware to optimize specific AI workloads ensures that each use case can achieve maximum performance and efficiency for diverse AI and other applications.

The disclosed approach for the AIFSP may enhance programmability for ISV and Original Equipment Manufacturers (OEMs) by leveraging direct micro-architectural optimizations. This includes defining new, lightweight Model Specific Registers (MSRs) and System Management Mode (SMM) functions that abstract the micro-architectural AI Affinity configuration profiles. The AIFSP may augment a runtime engine, configuring it correctly based on the workload or workload mix. This may trigger appropriate AIFSP adjustments via runtime Just-In-Time (JIT) code generation across various instruction sets, including SSE, AVX2, AVX3, and AMX. Additionally, the AIFSP may function as a micro-code virtualization layer under the control of ISV or OEM system management. MSRs can be mapped to trigger actions within the AIFSP, which in turn triggers specific code paths to enforce appropriate profiles based on configurable policies.

AIFSP feature support includes various optimizations and configurations such as pre-fetcher choices (e.g. specific pre-fetcher algorithms), dynamic license changes based on power and performance metrics, and power gate or hysteresis adjustments for vector processing units. It also offers choices for instruction set dispatch and microcode generation based on platform configuration parameters like the number of processor cores, the configuration of cache hierarchy, and interconnect settings. These features ensure that the firmware is optimized for the specific hardware configuration and workload, maximizing performance and efficiency for AI applications.

The AIFSP may allow chip manufacturers and their partners to launch silicon vendor-provided acceleration features that are opaque to any customization by ISVs or OEMs.

MSRs are currently used in system architecture used for performance monitoring. The disclosure approach introduces a method for using MSRs familiar to customers across different chip manufacturers. This method may trap into manufacturer-owned or even ISV-customized firmware profiles for efficient profile mapping.

Additionally, the disclosed approach may be applicable beyond traditional processor (e.g. x86) cores. Various blocks or accelerators can also utilize this MSR interface. The firmware support package may function as a proxy to program these other elements, providing a consistent programming environment across the ecosystem. This ensures that various components within the system can be efficiently managed and optimized using a unified framework.

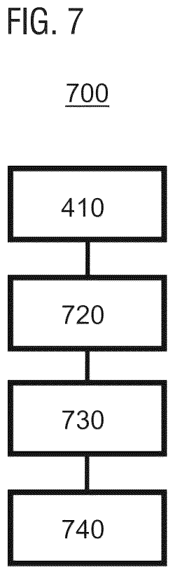

FIG. 1 further shows that the apparatus 10 comprises circuitry to provide the functionality of the apparatus 10. For example, the circuitry of the apparatus 10 may be configured to provide the functionality of the apparatus 10. For example, the apparatus 10 of FIG. 1 includes optional interface circuitry 40, processor circuitry 30, and memory circuitry 20. For example, the processor circuitry 30 may be coupled with the interface circuitry 40 and the memory circuitry 20. For example, the processor circuitry 30 may provide the functionality of the apparatus, in conjunction with the interface circuitry 40 (for exchanging information, such as with other components inside or outside the computer system 100 comprising the apparatus 10 or device 10), the memory circuitry 20 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or be implemented by, the respective structural components of the apparatus 10. For example, the device 10 of FIG. 1 includes means for processing 30, which may correspond to or be implemented by the processor circuitry 30, means for communicating 40, which may correspond to or be implemented by the interface circuitry 40, (optional) means for storing information 20, which may correspond to or be implemented by the memory circuitry 20. In general, the functionality of the processor circuitry 30 or means for processing 30 may be implemented by the processor circuitry 30 or means for processing 30 executing machine-readable instructions. Accordingly, any feature ascribed to the processor circuitry 30 or means for processing 30 may be defined by one or more instructions of a plurality of machine-readable instructions. The apparatus 10 or device 10 may comprise the machine-readable instructions, e.g. within the memory circuitry 20, a storage circuitry (not shown), or a means for storing information 20. For example, the processor circuitry 30 or means for processing 30 may perform a method shown in the present disclosure, such as the method discussed in connection with FIG. 7.

The interface circuitry 40 or means for communicating 40 may correspond to one or more inputs and/or outputs for receiving and/or transmitting information, which may be in digital (bit) values according to a specified code, within a module, between modules or between modules of different entities. For example, the interface circuitry 40 or means for communicating 40 may comprise circuitry configured to receive and/or transmit information.

For example, the processor circuitry 30 or means for processing 30 may be implemented using one or more processing units, one or more processing devices, or any means for processing, such as a processor, a computer, or a programmable hardware component being operable with accordingly adapted software. In other words, the described function of the processor circuitry 30 or means for processing may as well be implemented in software, which is then executed on one or more programmable hardware components. Such hardware components may comprise a general-purpose processor, a Digital Signal Processor (DSP), a microcontroller, etc.

For example, the memory circuitry 20 or means for storing information 20 may be a volatile memory, e.g. random access memory, such as dynamic random-access memory (DRAM) or static random-access memory (SRAM).

FIG. 1 further shows system 100 comprising processor circuitry 30, and a non-transitory, machine-readable medium 20 storing program code 20a. The processor circuitry 30 may be coupled to the machine-readable medium 20 via a memory channel. The program code 20a, when executed by the processor circuitry 30, enables the system 100 to reconfigure a support package for initializing firmware. The system may be configured to intercept a write operation to a register of the processor circuitry 30 requesting a configuration profile for the support package, select an applet for the support package corresponding to the requested configuration profile, reconfigure the support package with the selected applet, and initialize firmware based on the reconfigured support package.

The computer system 100 may be at least one of a client computer system, a server computer system, a rack server, a desktop computer system, a mobile computer system, a security gateway, and a router. The mobile device 100 may be a smartphone, tablet, wearable, or mobile computer.

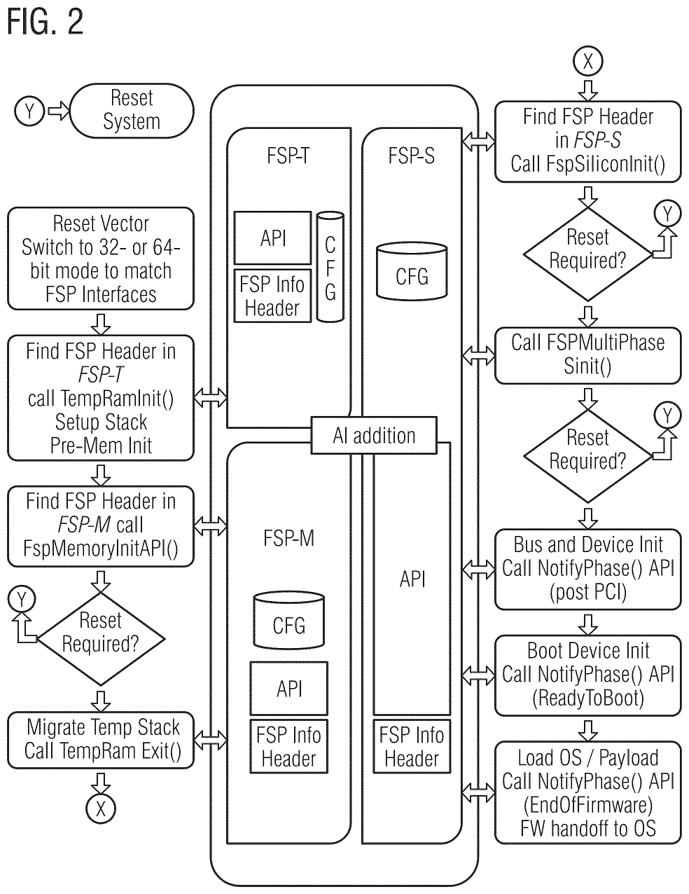

More details and optional aspects of the device of FIG. 1 may be described in connection with examples described below (e.g. FIGS. 2 to 8).

FIG. 2 illustrates the overall augmentation of a FSP with an AIFSP. In addition to the AIFSP, FIG. 2 shows different FSPs used to optimize system performance and initialization aspects. The FSP-T (Timing FSP) is focused on optimizing the timing parameters of the system. It ensures that components such as memory, buses, and processors operate with optimal timing settings to improve overall system efficiency and performance. The FSP-M (Memory FSP) is dedicated to configuring and optimizing the memory subsystem of the platform. It includes settings and initializations for memory controllers, memory timings, and other related parameters to ensure maximum memory performance and stability. The FSP-S(Security FSP) is designed to manage the security aspects of system initialization. It includes configurations and initializations for security features such as secure boot, encryption, and other security protocols to protect the system from unauthorized access and vulnerabilities. These distinct types of FSPs allow for specialized optimizations tailored to different critical aspects of system performance, ensuring a balanced and efficient initialization process

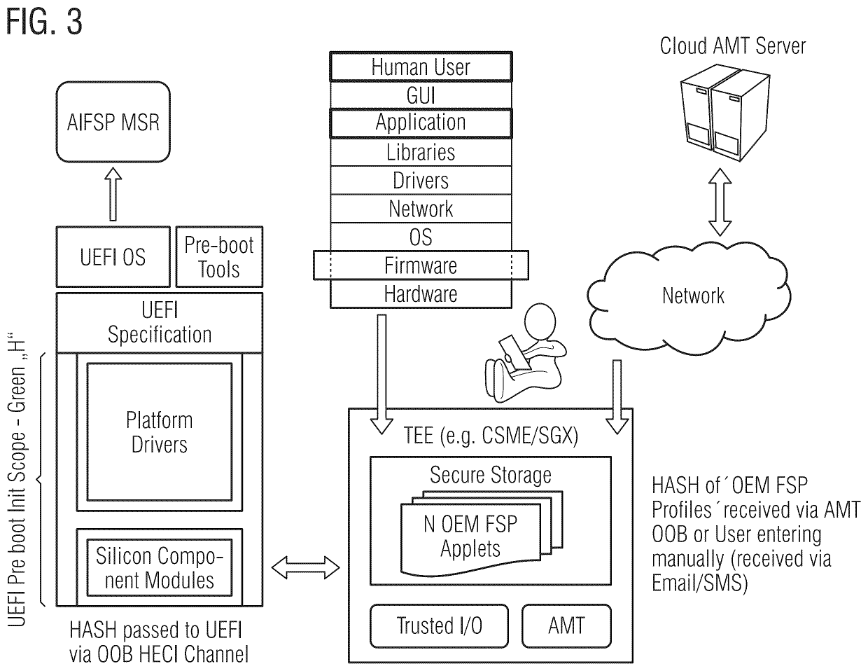

More details and aspects of the concept for reconfiguring a support package for initializing firmware may be described in connection with examples discussed above (e.g. FIG. 1) or below (e.g. FIGS. 3 to 8).

FIG. 3 illustrates a system architecture for a FSP with the addition of the AIFSP. The platform's Trusted Execution Environment (TEE) may be leveraged to dynamically update or select different FSP applets to be enforced for a server by the fleet manager.

The applet may be one of a plurality of applets for the support package. Each of the plurality of applets for the support package may comprise optimizations for artificial intelligence (AI) workloads. An applet is a small program that performs specific tasks within the support package, which is a collection of software and firmware components used to initialize hardware. By having multiple applets optimized for AI or other workloads, the system can dynamically select and execute the most appropriate applet for a given task, thereby improving the performance and efficiency of AI applications.

The configuration profile may be one of a plurality of configuration profiles, with the solution further configured to identify one or more apparatus capabilities to determine the plurality of configuration profiles. A configuration profile is a predefined set of settings and parameters for configuring an apparatus's hardware and software components. Identifying apparatus capabilities to determine the appropriate configuration profile ensures the system is optimally configured for the specific hardware and software environment, enhancing overall performance and reliability.

Additionally, the solution may be configured to query for a plurality of applets for the support package that are compatible with one or more apparatus capabilities. They may also be configured to query for a further applet corresponding to the requested configuration profile. Furthermore, the solution may be configured to obtain support package usage information from one or more applications running on the apparatus, wherein the applet selection is based on the obtained support package usage information.

Apparatus capabilities refer to the specific features and functions of a system's hardware and software components. Querying compatible applets and obtaining usage information from running applications allows the system to select the most suitable applet, optimizing performance based on real-time data and application requirements.

The applet selection may also be based on one or more apparatus capabilities. Moreover, the solution may be configured to configure a kernel based on the reconfigured support package. Additionally, the solution may be configured to sandbox and benchmark the kernel before dispatching the kernel for execution. A kernel is the core part of an operating system that manages system resources and hardware communication. Configuring, sandboxing, and benchmarking the kernel based on the reconfigured support package ensures that the kernel operates efficiently and securely, improving system stability and performance before full deployment.

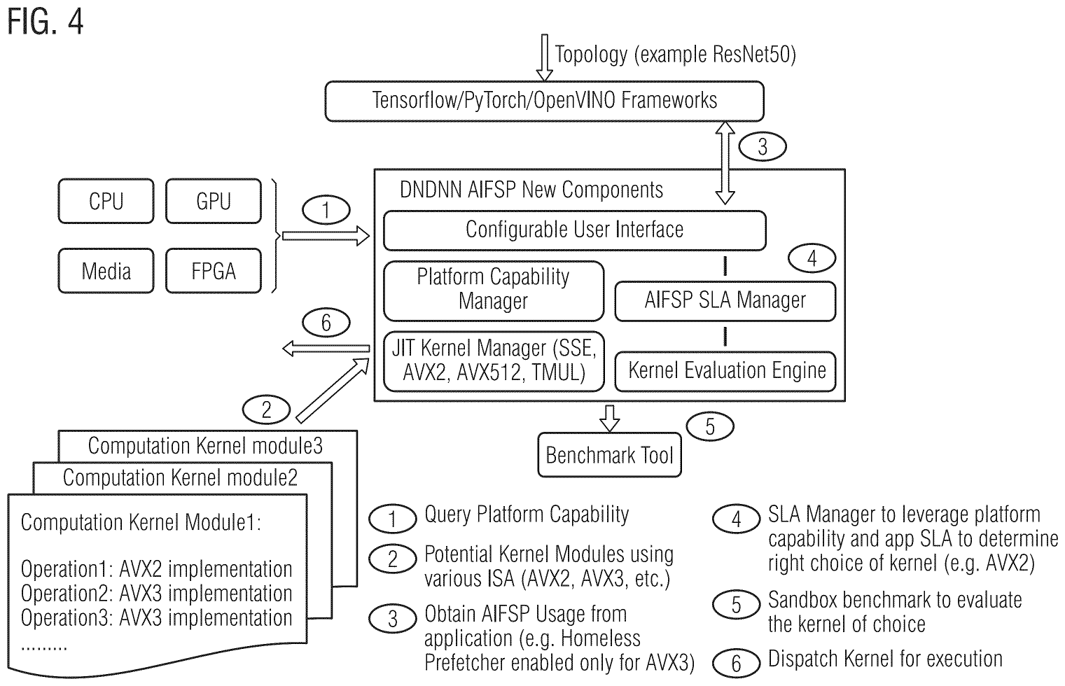

More details and aspects of the concept for reconfiguring a support package for initializing firmware may be described in connection with examples discussed above (e.g. FIGS. 1 and 2) or below (e.g. FIGS. 4 to 8).

FIG. 4 illustrates a system architecture with components to support reconfiguring the FSP highlighted. Key components involve a Configurable User Interface, a Platform Capability Manager, a JIT Manager, and a Kernel Evaluation Engine.

The disclosed solution may further be configured to provide a user interface for initiating the write operation to the register, wherein the user interface allows a user to request a change to the support package, and the user interface translates the change to a corresponding write operation. The solution may also be configured to update the user interface based on a plurality of applets that are compatible with one or more apparatus capabilities. A user interface is a software component that allows users to interact with the system, including making configuration changes. Providing a user-friendly interface for initiating write operations and updating it based on compatible applets makes it easier for users to manage and optimize the support package, enhancing user experience and system configurability.

The Configurable User Interface component provides the user interface via the oneDNN and oneAPI stack for application middleware and frameworks to configure the AIFSP. oneDNN (oneAPI Deep Neural Network Library) is an open-source performance library designed to accelerate deep learning applications. It provides highly optimized building blocks for deep learning operations such as convolutional neural networks, recurrent neural networks, and other machine learning algorithms. The library is part of the oneAPI initiative to enable high-performance, cross-architecture computing for both CPUs and accelerators like GPUs. oneAPI is an open, unified programming model designed to simplify the development of applications across diverse computing architectures, including CPUs, GPUs, FPGAs, and other accelerators. The oneAPI initiative includes a collection of libraries and tools that provide optimized performance for various computing tasks. It allows developers to write code that can run on multiple types of hardware using a single, consistent programming model, thereby reducing the complexity and cost associated with developing for heterogeneous systems.

The Platform Capability Manage software component identifies the target AIFSP capabilities (e.g. central processing unit (CPU) identification) and interacts with the user interface via the oneDNN and oneAPI stack. This interaction allows applications to configure the Just-In-Time (JIT) kernel configuration based on the platform's AIFSP capabilities. The JIT Manager is responsible for generating and managing dynamic JIT kernels based on specified service level agreements (SLAs) in conjunction with bare-metal and virtual machine (VM) heuristics observed in past operations. The Kernel Evaluation Engine may perform a quick sandbox evaluation of newly generated kernels and operations before they are deployed on a large scale.

The applet may be binary and encrypted. Additionally, the apparatus may use a TEE to reconfigure the support package. The solution may also be configured to verify the selected applet before reconfiguring the support package. A TEE is a secure processor area that ensures code and data integrity and confidentiality. Encrypted applets and a TEE for reconfiguration may provide enhanced security, ensuring that only verified and trusted applets are executed, thereby protecting the system from malicious software and unauthorized changes.

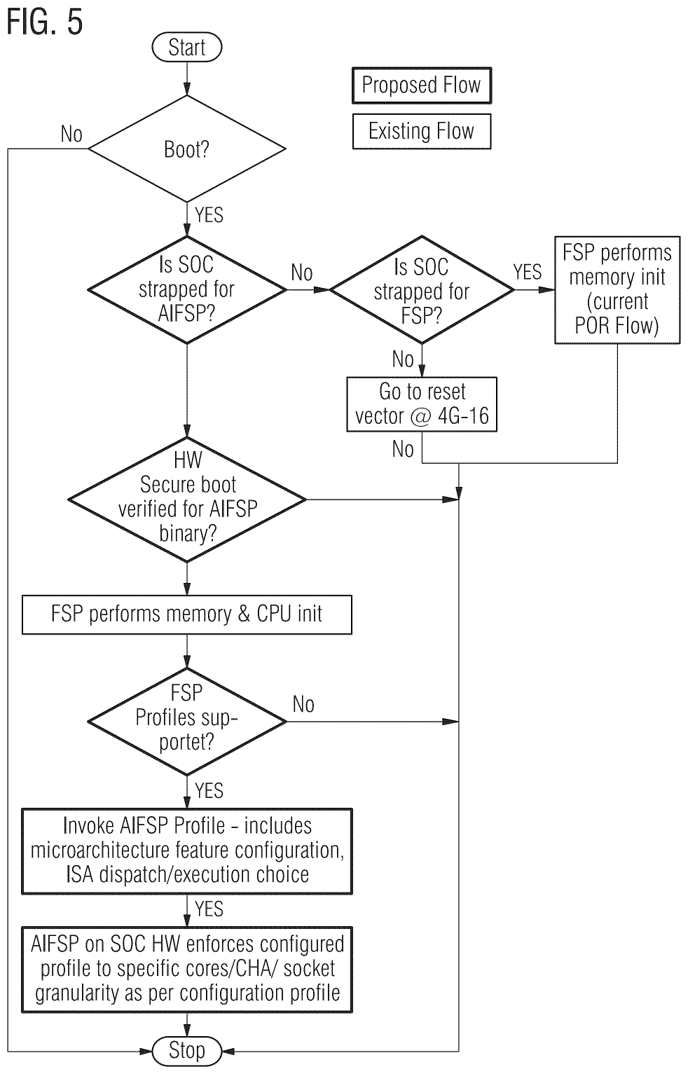

More details and aspects of the concept for reconfiguring a support package for initializing firmware may be described in connection with examples discussed above (e.g. FIGS. 1 to 3) or below (e.g. FIGS. 5 to 8).

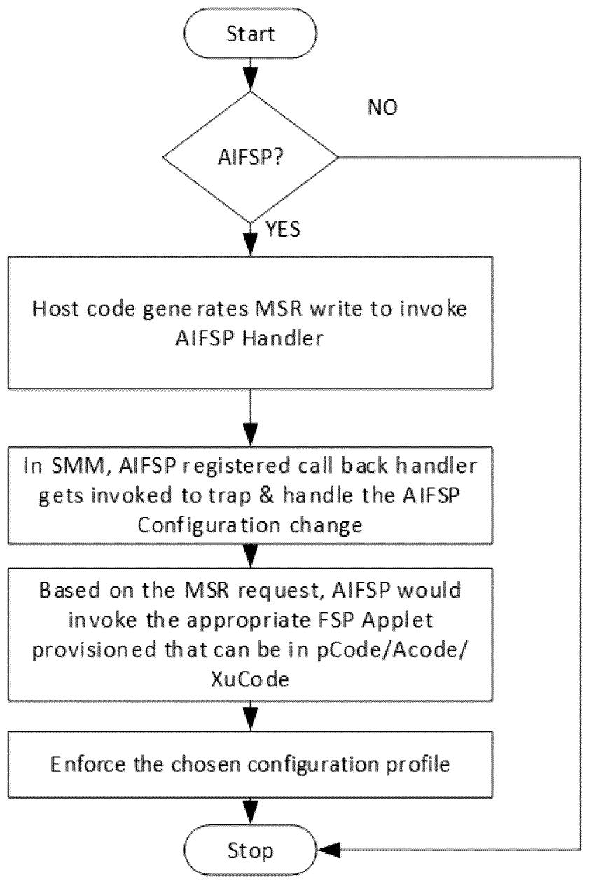

FIGS. 5 and 6 show flowcharts of fleet manager processes involving the AIFSP. FIG. 5 shows the configurational flow to enable AIFSP by a fleet manager, and FIG. 6 shows the operational flow to trigger AIFSP applets from host code that has been pre-configured by the fleet manager. The disclosed solution may be configured to communicate with a fleet manager to receive updated configuration profiles and applets for the support package. The solution may also be configured to generate an instruction set architecture based on one or more invocation parameters of the applet. Finally, the solution may be configured to log telemetry data from the firmware initialized by the applet, wherein the data includes at least one of power, performance, or thermal data.

A fleet manager is a system or software that manages many devices or systems, typically in a data center or cloud environment. Communicating with a fleet manager for updates ensures that all systems are consistently and efficiently configured. Generating an instruction set architecture based on applet parameters and logging telemetry data enables continuous monitoring and optimization, improving system performance, power management, and thermal efficiency.

More details and aspects of the concept for reconfiguring a support package for initializing firmware may be described in connection with examples discussed above (e.g. FIGS. 1 to 4) or below (e.g. FIGS. 7 and).

FIG. 7 shows a flowchart of a method 700 for prioritizing a plurality of applications based on memory bandwidth utilization. The method 700 may comprise intercepting 710 a write operation to a register of the processor circuitry requesting a configuration profile for the support package, selecting 720 an applet for the support package corresponding to the requested configuration profile, reconfiguring 730 the support package with the selected applet, and 740 initializing firmware based on the reconfigured support package.

When a chip manufacturer enables cloud providers or OEMs, they provide reference code for a BIOS encapsulated in a well-formed binary, which includes critical initializations. This binary, known as the FSP, is integrated by OEMs to build their BIOS on top of it. The FSP sets performance-related Model Specific Registers (MSRs) and is incorporated into the BIOS, covering code runtime without publicly disclosing the specifics of these registers. OEMs often take the reference BIOS and write code for their own platforms, often ignoring some optimizations embedded in the BIOS. However, most optimizations are embedded in the FSP, allowing customers to benefit even if the BIOS ignores these optimizations. The FSP can reconfigure bandwidth and other parameters, optimizing memory latency for running large language models. For instance, an OEM can buy a chip from the manufacturer, integrate the FSP, build the BIOS on top of it, and then layer an operating system on top of that. The method focuses on reprogramming the memory interface, fabric, and generating code generators on System on Chip (SoC). Performance settings are better for databases, and profiles can be based on workloads. Anytime ISP vendors ignore some BIOS optimizations embedded in the reference BIOS, value is lost. Embedding these elements as part of the FSP logic allows for BIOS upgrades or packages by the chip manufacturer or third parties. Based on the FSP bundled in the platform, just-in-time code generation for interpretation-based languages can streamline the FSP package. This brings power efficiency knobs to operating systems and programs, enabling MSR registers to generate or adapt in the field. From a customer perspective, changing the BIOS for a specific usage typically requires a server reboot, which is undesirable. Moving configurations from the BIOS into the FSP package can avoid reboots and can be enabled for GPUs or other NPUs.

Optionally or alternatively, the method 700 may further comprise querying for a plurality of applets for the support package that are compatible with one or more apparatus capabilities. Optionally or alternatively, method 700 may further comprise querying for a further applet corresponding to the requested configuration profile. Optionally or alternatively, method 700 may further comprise obtaining support package usage information from one or more applications running on the apparatus, wherein the selection of the applet is based on the obtained support package usage information. Optionally or alternatively, method 700 may further comprise configuring a kernel based on the reconfigured support package. Optionally or alternatively, method 700 may further comprise sandboxing and benchmarking the kernel before dispatching the kernel for execution. Optionally or alternatively, method 700 may further comprise providing a user interface for initiating the write operation to the register, wherein the user interface allows a user to request a change to the support package and the user interface translates the change to a corresponding write operation. Optionally or alternatively, method 700 may further comprise updating the user interface based on a plurality of applets that are compatible with one or more apparatus capabilities. Optionally or alternatively, method 700 may further comprise updating verifying the selected applet before reconfiguring the support package. Optionally or alternatively, method 700 may further comprise updating communicating with a fleet manager to receive updated configuration profiles and applets for the support package. Optionally or alternatively, method 700 may further comprise updating generating an instruction set architecture based on one or more invocation parameters of the applet. Optionally or alternatively, method 700 may further comprise updating logging telemetry data from the firmware initialized by the applet, wherein the data includes at least one of power, performance, or thermal data.

The method may support various computing tasks based on runtime workload analysis. For example, if performance does not meet expectations, the system can switch to other performance optimizations. Runtime triggers such as thermal profile telemetry, power thresholds, and performance metrics can prompt updates. These updates can be executed without needing to change the BIOS, leveraging FSP to fill in gaps and continue support.

The method ensures long-term support and optimization for today's workloads, including generative AI and other advanced computing tasks. Some configurations that do not work today may become viable in the future as hardware and software evolve. For example, new FSP packages can be deployed via updates to optimize large language models or other demanding applications.

The method for reconfiguring a support package for initializing firmware provides a flexible, dynamic method to optimize hardware configurations. By abstracting critical initialization tasks into the FSP and enabling real-time adjustments through AIFSP, the system ensures efficient performance tailored to specific workloads and operational conditions. This method reduces the need for disruptive BIOS changes, instead relying on sophisticated firmware packages to manage hardware configurations seamlessly.

A non-transitory, machine-readable medium storing program code may, when the program code is executed by processor circuitry, a computer, or a programmable hardware component, cause the processor circuitry, the computer, or the programmable hardware component to perform the method 700.

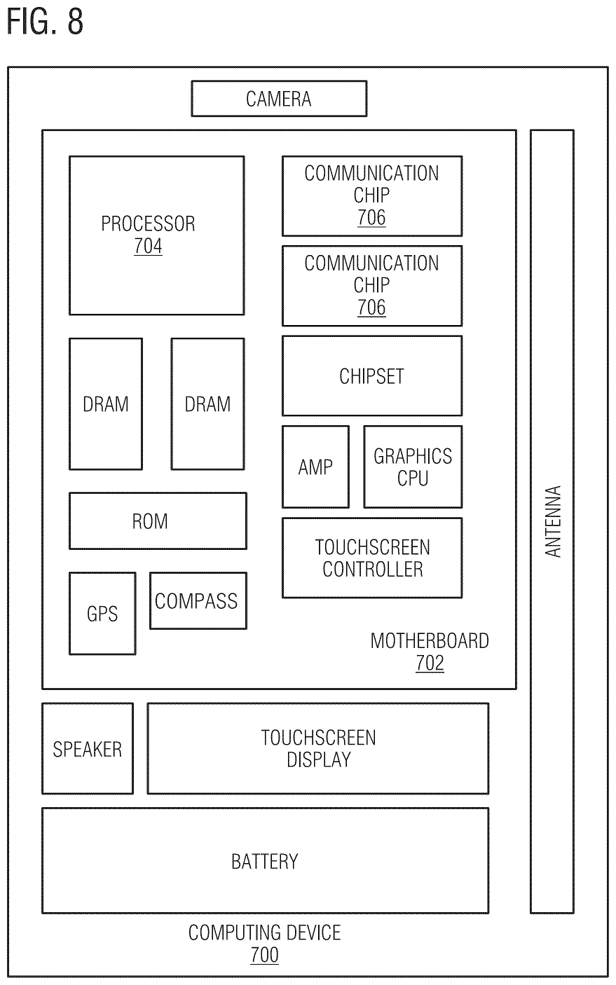

More details and aspects of the concept for reconfiguring a support package for initializing firmware may be described in connection with examples discussed above (e.g. FIGS. 1 to 7) or below (e.g. FIG. 8).

FIG. 8 shows illustrates a computing device 700 in accordance with one implementation of the invention. The computing device 700 houses a board 702. The board 702 may include a number of components, including but not limited to a processor 704 and at least one communication chip 706. The processor 704 is physically and electrically coupled to the board 702. In some implementations the at least one communication chip 706 is also physically and electrically coupled to the board 702. In further implementations, the communication chip 706 is part of the processor 704.

Depending on its applications, computing device 700 may include other components that may or may not be physically and electrically coupled to the board 702. These other components include, but are not limited to, volatile memory (e.g. DRAM), non-volatile memory (such as, ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as, hard disk drive, compact disk (CD), digital versatile disk (DVD), and so forth).

The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter range wireless communications such as Wi-Fi and Bluetooth and a second communication chip 706 may be dedicated to longer range wireless communications such as GPS, EDGE, GPRS, CDMA, WiMAX, LTE, Ev-DO, and others.

The processor 704 of the computing device 700 includes an integrated circuit die packaged within the processor 704. In some implementations of the invention, the integrated circuit die of the processor includes one or more devices that are assembled in an ePLB or eWLB based PoP package that that includes a mold layer directly contacting a substrate, in accordance with implementations of the invention. The term “processor” may refer to any device or portion of a device that processes electronic data from registers and/or memory to transform that electronic data into other electronic data that may be stored in registers and/or memory.

The communication chip 706 also includes an integrated circuit die packaged within the communication chip 706. In accordance with another implementation of the invention, the integrated circuit die of the communication chip includes one or more devices that are assembled in an ePLB or eWLB based POP package that that includes a mold layer directly contacting a substrate, in accordance with implementations of the invention.

More details and aspects of the concept for reconfiguring a support package for initializing firmware are mentioned in connection with the proposed concept or one or more examples described above (e.g. FIGS. 1 to 8) or below. The concept for reconfiguring a support package for initializing firmware may comprise one or more additional optional features corresponding to one or more aspects of the proposed concept or one or more examples described above or below.

The aspects and features described in relation to a particular one of the previous examples may also be combined with one or more of the further examples to replace an identical or similar feature of that further example or to additionally introduce the features into the further example.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

An example (e.g. example 1) relates to an apparatus for reconfiguring a support package for initializing firmware, the apparatus comprising memory, machine-readable instructions, and processor circuitry configured to execute the machine-readable instructions to: intercept a write operation to a register of the processor circuitry requesting a configuration profile for the support package; select an applet for the support package corresponding to the requested configuration profile; reconfigure the support package with the selected applet; and initialize firmware based on the reconfigured support package.

Another example (e.g. example 2) relates to a previously described example (e.g. example 1), wherein the applet is one of a plurality of applets for the support package.

Another example (e.g. example 3) relates to a previously described example (e.g. example 2), wherein each of the plurality of applets for the support package comprises optimizations for artificial intelligence workloads.

Another example (e.g. example 4) relates to a previously described example (e.g. any one of examples 1 to 3), wherein the configuration profile is one of a plurality of configuration profiles, further comprising the machine-readable instructions to identify one or more apparatus capabilities to determine the plurality of configuration profiles.

Another example (e.g. example 5) relates to a previously described example (e.g. any one of examples 1 to 4), further comprising the machine-readable instructions to query for a plurality of applets for the support package that are compatible with one or more apparatus capabilities.

Another example (e.g. example 6) relates to a previously described example (e.g. any one of examples 1 to 5), further comprising the machine-readable instructions to query for a further applet corresponding to the requested configuration profile.

Another example (e.g. example 7) relates to a previously described example (e.g. any one of examples 1 to 6), further comprising the machine-readable instructions to obtain support package usage information from one or more applications running on the apparatus, wherein the selection of the applet is based on the obtained support package usage information.

Another example (e.g. example 8) relates to a previously described example (e.g. any one of examples 1 to 7), wherein the selection of the applet is based on one or more apparatus capabilities.

Another example (e.g. example 9) relates to a previously described example (e.g. any one of examples 1 to 8), further comprising the machine-readable instructions to configure a kernel based on the reconfigured support package.

Another example (e.g. example 10) relates to a previously described example (e.g. example 9), further comprising the machine-readable instructions to sandbox and benchmark the kernel before dispatching the kernel for execution.

Another example (e.g. example 11) relates to a previously described example (e.g. any one of examples 1 to 9), further comprising the machine-readable instructions to provide a user interface for initiating the write operation to the register, wherein the user interface allows a user to request a change to the support package and the user interface translates the change to a corresponding write operation.

Another example (e.g. example 12) relates to a previously described example (e.g. example 11), further comprising the machine-readable instructions to update the user interface based on a plurality of applets that are compatible with one or more apparatus capabilities.

Another example (e.g. example 13) relates to a previously described example (e.g. any one of examples 1 to 12), wherein the applet is binary and encrypted.

Another example (e.g. example 14) relates to a previously described example (e.g. any one of examples 1 to 13), wherein the apparatus uses a Trusted Execution Environment (TEE) to reconfigure the support package.

Another example (e.g. example 15) relates to a previously described example (e.g. any one of examples 1 to 14), further comprising the machine-readable instructions to verify the selected applet before reconfiguring the support package.

Another example (e.g. example 16) relates to a previously described example (e.g. any one of examples 1 to 15), further comprising the machine-readable instructions to communicate with a fleet manager to receive updated configuration profiles and applets for the support package.

Another example (e.g. example 17) relates to a previously described example (e.g. any one of examples 1 to 16), further comprising the machine-readable instructions to generate an instruction set architecture based on one or more invocation parameters of the applet.

Another example (e.g. example 18) relates to a previously described example (e.g. any one of examples 1 to 17), further comprising the machine-readable instructions to log telemetry data from the firmware initialized by the applet, wherein the data includes at least one of power, performance, or thermal data.

An example (e.g. example 19) relates to a method for reconfiguring a support package for initializing firmware, the method comprising: intercepting a write operation to a register of the processor circuitry requesting a configuration profile for the support package; selecting an applet for the support package corresponding to the requested configuration profile; reconfiguring the support package with the selected applet; and initializing firmware based on the reconfigured support package.

Another example (e.g. example 20) relates to a previously described example (e.g. example 19), wherein the applet is one of a plurality of applets for the support package.

Another example (e.g. example 21) relates to a previously described example (e.g. example 20), wherein each of the plurality of applets for the support package comprises optimizations for artificial intelligence workloads.

Another example (e.g. example 22) relates to a previously described example (e.g. any one of examples 19 to 21), wherein the configuration profile is one of a plurality of configuration profiles, further comprising the machine-readable instructions to identify one or more apparatus capabilities to determine the plurality of configuration profiles.

Another example (e.g. example 23) relates to a previously described example (e.g. any one of examples 19 to 22), further comprising querying for a plurality of applets for the support package that are compatible with one or more apparatus capabilities.

Another example (e.g. example 24) relates to a previously described example (e.g. any one of examples 19 to 23), further comprising querying for a further applet corresponding to the requested configuration profile.

Another example (e.g. example 25) relates to a previously described example (e.g. any one of examples 19 to 24), further comprising obtaining support package usage information from one or more applications running on the apparatus, wherein the selection of the applet is based on the obtained support package usage information.

Another example (e.g. example 26) relates to a previously described example (e.g. any one of examples 19 to 25), wherein the selection of the applet is based on one or more apparatus capabilities.

Another example (e.g. example 27) relates to a previously described example (e.g. any one of examples 19 to 26), further comprising configuring a kernel based on the reconfigured support package.

Another example (e.g. example 28) relates to a previously described example (e.g. example 27), further comprising sandboxing and benchmarking the kernel before dispatching the kernel for execution.

Another example (e.g. example 29) relates to a previously described example (e.g. any one of examples 19 to 27), further comprising providing a user interface for initiating the write operation to the register, wherein the user interface allows a user to request a change to the support package and the user interface translates the change to a corresponding write operation.

Another example (e.g. example 30) relates to a previously described example (e.g. example 29), further comprising the updating the user interface based on a plurality of applets that are compatible with one or more apparatus capabilities.

Another example (e.g. example 31) relates to a previously described example (e.g. any one of examples 19 to 30), wherein the applet is binary and encrypted.

Another example (e.g. example 32) relates to a previously described example (e.g. any one of examples 19 to 31), wherein the apparatus uses a Trusted Execution Environment (TEE) to reconfigure the support package.

Another example (e.g. example 33) relates to a previously described example (e.g. any one of examples 19 to 32), further comprising verifying the selected applet before reconfiguring the support package.

Another example (e.g. example 34) relates to a previously described example (e.g. any one of examples 19 to 33), further comprising communicating with a fleet manager to receive updated configuration profiles and applets for the support package.

Another example (e.g. example 35) relates to a previously described example (e.g. any one of examples 19 to 34), further comprising generating an instruction set architecture based on one or more invocation parameters of the applet.

Another example (e.g. example 36) relates to a previously described example (e.g. any one of examples 19 to 35), further comprising logging telemetry data from the firmware initialized by the applet, wherein the data includes at least one of power, performance, or thermal data.

An example (e.g. example 37) relates to a non-transitory, computer-readable medium comprising a program code that, when the program code is executed on a processor, a computer, or a programmable hardware component, causes the processor, computer, or programmable hardware component to perform any one of the methods a previously described example (e.g. any one of examples 19 to 36).

The aspects and features described in relation to a particular one of the previous examples may also be combined with one or more of the further examples to replace an identical or similar feature of that further example or to additionally introduce the features into the further example.

Examples may further be or relate to a (computer) program, including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable, or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes, or -operations.

If some aspects have been described in relation to a device or system, these aspects should also be understood as a description of the corresponding method. For example, a block, device, or functional aspect of the device or system may correspond to a feature, such as a method step, of the corresponding method. Accordingly, aspects described in relation to a method shall also be understood as a description of a corresponding block, a corresponding element, a property, or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product (e.g. machine-readable instructions, program code, etc.). Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g. via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect, feature, or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although, in the claims, a dependent claim refers to a particular combination with one or more other claims, other examples may also include a combination of the dependent claim with the subject matter of any other dependent or independent claim. Such combinations are hereby explicitly proposed unless it is stated in the individual case that a particular combination is not intended. Furthermore, features of a claim should also be included for any other independent claim, even if that claim is not directly defined as dependent on that other independent claim.

What is claimed is:

1. An apparatus for reconfiguring a support package for initializing firmware, the apparatus comprising memory, machine-readable instructions, and processor circuitry configured to execute the machine-readable instructions to:
intercept a write operation to a register of the processor circuitry requesting a configuration profile for the support package;
select an applet for the support package corresponding to the requested configuration profile;
reconfigure the support package with the selected applet; and
initialize firmware based on the reconfigured support package.

2. The apparatus of claim 1, wherein the applet is one of a plurality applets for the support package.

3. The apparatus of claim 2, wherein each of the plurality applets for the support package comprise optimizations for artificial intelligence workloads.

4. The apparatus of claim 1, wherein the configuration profile is one of a plurality of configuration profiles, further comprising the machine-readable instructions to identify one or more apparatus capabilities to determine the plurality of configuration profiles.

5. The apparatus of claim 1, further comprising the machine-readable instructions to query for a plurality of applets for the support package that are compatible with one or more apparatus capabilities.

6. The apparatus of claim 1, further comprising the machine-readable instructions to query for a further applet corresponding to the requested configuration profile.

7. The apparatus of claim 1, further comprising the machine-readable instructions to:
obtain support package usage information from one or more applications running on the apparatus, wherein the selection of the applet is based on the obtained support package usage information.

8. The apparatus of claim 1, wherein the selection of the applet is based on one or more apparatus capabilities.

9. The apparatus of claim 1, further comprising the machine-readable instructions to:
configure a kernel based on the reconfigured support package.

10. The apparatus of claim 9, further comprising the machine-readable instructions to:
sandbox and benchmark the kernel before dispatching the kernel for execution.

11. The apparatus of claim 1, further comprising the machine-readable instructions to:
provide a user interface for initiating the write operation to the register, wherein the user interface allows a user to request a change to the support package and the user interface translates the change to a corresponding write operation.

12. The apparatus of claim 11, further comprising the machine-readable instructions to:
update the user interface based on a plurality of applets that are compatible with one or more apparatus capabilities.

13. The apparatus of claim 1, wherein the applet is binary and encrypted.

14. The apparatus of claim 1, wherein the apparatus uses a Trusted Execution Environment (TEE) to reconfiguring the support package.

15. The apparatus of claim 1, further comprising the machine-readable instructions to verify the selected applet before reconfiguring the support package.

16. The apparatus of claim 1, further comprising the machine-readable instructions to communicate with a fleet manager to receive updated configuration profiles and applets for the support package.

17. The apparatus of claim 1, further comprising the machine-readable instructions to generate an instruction set architecture based on one or more invocation parameters of the applet.

18. The apparatus of claim 1, further comprising the machine-readable instructions to log telemetry data from the firmware initialized by the applet, wherein the data includes at least one of power, performance, or thermal data.

19. A method for reconfiguring a support package for initializing firmware, the method comprising:
intercepting a write operation to a register of the processor circuitry requesting a configuration profile for the support package;
selecting an applet for the support package corresponding to the requested configuration profile;
reconfiguring the support package with the selected applet; and
initializing firmware based on the reconfigured support package.

20. A non-transitory, computer-readable medium comprising a program code that, when the program code is executed on a processor, a computer, or a programmable hardware component, causes the processor, computer, or programmable hardware component to perform the method of claim 19.
